(19) United States
(12) Patent Application Publication
(10) Pub. No.: US 2026/0168964 A1
(43) Pub. Date: Jun. 18, 2026

(54) ULTRASOUND FLAW DETECTION

(71) Applicant: AIRBUS (S.A.S.), Blagnac (FR)

(72) Inventors: Sagnik CHAKRABORTY, Bristol (GB); Tejas Shriprakash TADPATRIKAR, Bristol (GB)

(21) Appl. No.: 19/423,548

(22) Filed: Dec. 17, 2025

(30) Foreign Application Priority Data
Dec. 18, 2024 (IN) 202411100447

(51) Int. Cl. G01N 29/04

(52) U.S. Cl. CPC G01N 29/048; G01N 29/045; G01N 2291/0289; G01N 2291/2694

(57) ABSTRACT

A method of indicating a position of a flaw in a part including holding a probe by hand in contact with a surface of the part with a probe; detecting a flaw in the part by emitting ultrasound from the probe into the surface of the part and detecting echoes of the ultrasound from the flaw; providing an indicator on the surface of the part indicating a detection position of the probe; after the indicator has been provided, removing the probe by hand from the surface of the part, leaving the indicator in place; and after the probe has been removed from the surface of the part, providing a flaw marker on the surface of the part indicating an estimated position of the flaw.

### CROSS RELATED APPLICATION

This application claims priority to Indian Patent Application IN 202411100447, filed Dec. 18, 2024, the entire contents of which is hereby incorporated by reference.

### FIELD OF THE INVENTION

The present invention relates to a method of indicating a position of a flaw in a part; and testing apparatus for use in such a method.

### BACKGROUND OF THE INVENTION

Manual ultrasound techniques for detecting flaws are known, but it can be difficult for such techniques to accurately detect a position of the flaw, particularly where the flaw is in a confined or congested space.

### SUMMARY OF THE INVENTION

A first aspect of the invention provides a method of indicating a position of a flaw in a part, the method comprising: holding a probe by hand in contact with a surface of the part with a probe; detecting a flaw in the part by emitting ultrasound from the probe into the surface of the part and detecting echoes of the ultrasound from the flaw; providing an indicator on the surface of the part indicating a detection position of the probe; after the indicator has been provided, removing the probe by hand from the surface of the part, leaving the indicator in place; and after the probe has been removed from the surface of the part, providing a flaw marker on the surface of the part indicating an estimated position of the flaw, wherein the flaw marker is spaced from the indicator and a position of the flaw marker is based on a position of the indicator; wherein the indicator comprises material deposited on the surface of the part at the detection position by a probe-mounted marking device which is mounted to the probe, or the indicator is a light indicator provided by a beam of light which illuminates the surface of the part at the detection position.

Optionally the position of the flaw marker is determined by measuring a preset distance from the position of the indicator.

Optionally the preset distance is measured by a ruler.

Optionally the flaw marker comprises material deposited by a hand-held device.

Optionally the method further comprises moving the probe across the surface of the part from a first position; monitoring ultrasound echoes until the probe reaches a second position where ultrasound echoes from the flaw are detected; then further moving the probe across the surface of the part from the second position and monitoring ultrasound echoes until the probe reaches the detection position where ultrasound echoes from the flaw have reduced to a level indicating a periphery of the flaw.

Optionally the flaw is a crack, and the periphery of the flaw is a tip of the crack.

Optionally the indicator comprises material deposited on the surface of the part at the detection position by a probe-mounted marking device which is mounted to the probe.

Optionally the indicator comprises graphite deposited on the surface of the part at the detection position by the probe-mounted marking device.

Optionally the indicator is a light indicator, such as a light spot, provided by a beam of light which illuminates the surface of the part at the detection position.

Optionally the ultrasound is emitted into the surface of the part by an ultrasound beam which is at an oblique angle to the surface of the part.

Optionally the probe comprises a wedge and an ultrasonic transducer mounted to the wedge.

Optionally the part is inside an aircraft wing.

A further aspect of the invention provides testing apparatus comprising: a probe configured to contact a surface of a part, the probe comprising a wedge and an ultrasonic transducer mounted to the wedge; and a probe-mounted marking device mounted to the probe, wherein the probe-mounted marking device is configured to provide an indicator on the surface of the part indicating a detection position of the probe by depositing material on the surface of a part.

Optionally the probe-mounted marking device comprises a pencil.

A further aspect of the invention provides testing apparatus comprising: a probe configured to contact a surface of a part, the probe comprising a wedge and an ultrasonic transducer mounted to the wedge; and a light source configured to provide a light indicator on the surface of the part indicating a detection position of the probe by illuminating the surface of the part at the detection position with a beam of light, wherein the probe can be moved relative to the light source so that the probe can be removed from the surface of the part, leaving the light indicator in place.

Optionally the testing apparatus further comprises a flexible light source support configured to support the light source and connect the flexible light source to a support structure, wherein the flexible light source support can be adjusted to move the light source relative to the support structure and move a position of the light indicator on the surface of the part.

Optionally the testing apparatus further comprises a control unit configured to operate the probe by energising the ultrasonic transducer; a flexible cable connecting the control unit to the probe; and a flexible light source support which supports the light source and connects the light source to the control unit, wherein the flexible light source support can be adjusted to move the light source relative to the control unit and move a position of the light indicator on the surface of the part.

### BRIEF DESCRIPTION OF THE DRAWINGS

Embodiments of the invention will now be described with reference to the accompanying drawings.

FIG. 1 shows an aircraft.

FIGS. 2 and 3 are cross-sectional views showing a calibration procedure.

FIG. 4 shows part of a spar flange, viewed from above.

FIG. 5 shows a fastener and a crack.

FIG. 6 is a sectional view showing the crack viewed from a first direction.

FIG. 7 is a sectional view showing the crack viewed from a second direction.

FIG. 8 shows the probe from above at a first position.

FIG. 9 is a sectional view showing the probe at the first position.

FIG. 10 shows the probe from above at a second position.

FIG. 11 is a sectional view showing the probe at the second position.

FIG. 12 shows the probe from above at a detection position.

FIG. 13 is a sectional view showing the probe at the detection position.

FIG. 14 shows a ruler being used to measure a preset distance D.

FIG. 15 shows an indicator and flaw marker after the ruler has been removed.

FIGS. 16 and 17 show the probe detecting an oblique crack which extends at an oblique angle to the spar web.

FIG. 18 shows an indicator and flaw marker for the oblique crack.

FIG. 19 shows an alternative indicator and flaw marker for the oblique crack.

FIG. 20 shows the probe detecting an offset crack which is offset from a centre of the fastener.

FIG. 21 shows an indicator and flaw marker for the offset crack.

FIG. 22 shows a testing apparatus with a light source attached to a control unit.

FIG. 23 shows a testing apparatus with a light source attached to a support structure.

FIG. 24 shows a light spot produced by the testing apparatus of FIG. 22 or FIG. 23.

FIG. 25 shows a ruler being used to measure a preset distance D from the light spot.

### DETAILED DESCRIPTION OF EMBODIMENT(S)

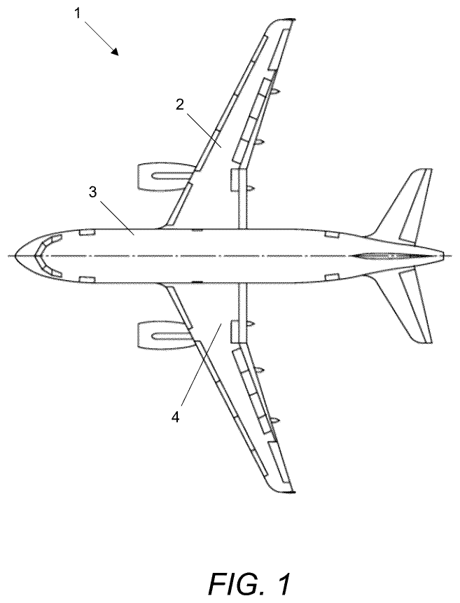

An aircraft 1 shown in FIG. 1 has a pair of wings 2 extending from a fuselage 3. Each wing has a pair of covers including an upper cover 4 visible in the plan view of FIG. 1. Inside each wing (and hence not visible in FIG. 1) is a pair of spars extending along the span of the wing, and ribs attached to the covers and to the spars.

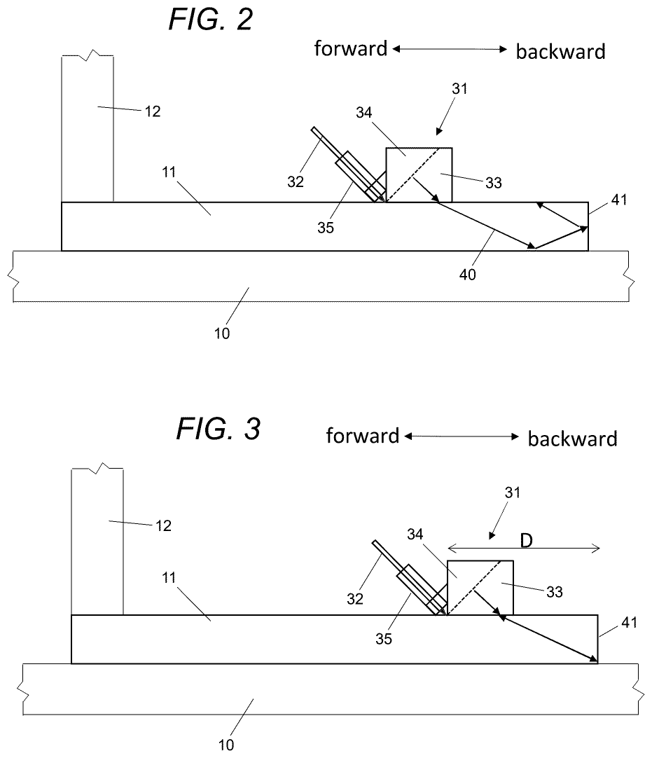

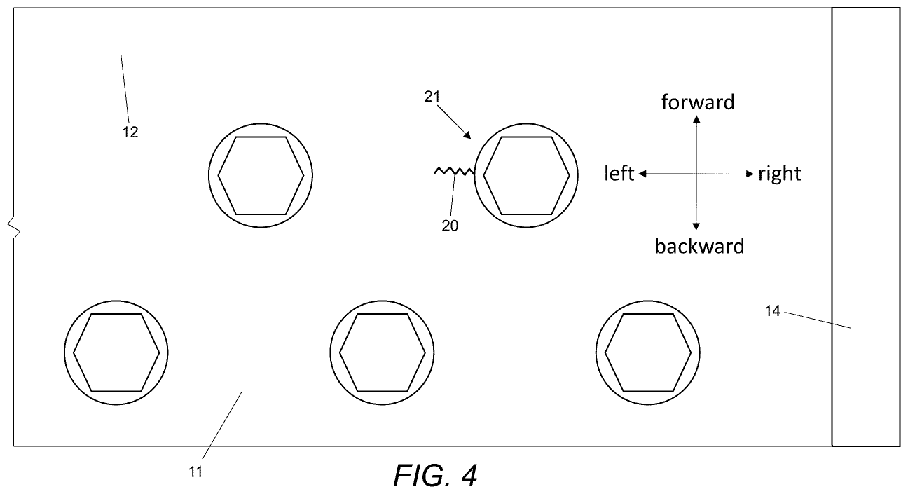

Each spar has a U-shaped cross-section with a spar web and a pair of spar flanges. Each spar flange is attached to a respective cover by fasteners. FIGS. 2 and 3 are cross-sectional views showing one of the covers (in this case the lower cover 10), a spar flange 11 and the bottom part of a spar web 12. FIG. 4 is a plan view showing part of the spar flange 11, the spar web 12, a rib 14, and six fasteners attaching the spar flange 11 to the cover 10. The spar flange 11 extends further to the left where it meets the next rib (not shown). The area between the ribs is known as a rib bay.

Non-destructive testing of the spar is occasionally required. This requires a human operator to enter the rib bay to conduct the testing. The rib bay may be very small, particularly towards the tip of the wing, which can make such testing difficult for the operator.

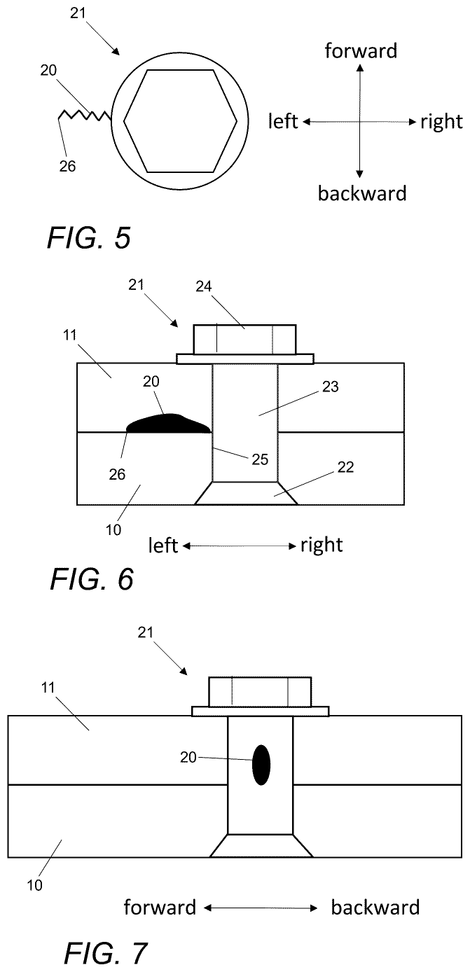

FIGS. 5-7 show one of the fasteners 21 in detail. The fastener 21 is a bolt with a head 22 lying flush with the aerodynamic outer surface of the cover 10, and a shaft 23 carrying a nut 24 inside the rib bay. The shaft 23 passes through a fastener hole 25. A crack 20 in the spar flange 11 extends from the fastener hole 25 to a crack tip 26. As shown in FIG. 4, the crack 20 extends to the left approximately parallel with the spar web 12.

An ultrasonic method of inspecting the spar is performed with testing apparatus shown in FIG. 2. The testing apparatus comprises a probe 31 configured to contact a surface of a part (in this case the upper surface of the spar flange 11) and a probe-mounted marking device (in this case a pencil 32) mounted to the probe 31 by a pencil holder 35. The probe 31 comprises a wedge 33 and an ultrasonic transducer 34 mounted to the wedge 33.

The transducer 34 may comprise a piezoelectric element, or any other active element suitable for producing an ultrasound beam. The wedge 33 is coupled to the transducer 34. A couplant (such as an oil layer) may be provided between the wedge 33 and the surface of the spar flange 11, and/or between the wedge 33 and the transducer 34.

An example of a suitable transducer 34 is the CEP18 (45°) or the CEP21 (60°) available from Sonaxis SA, of Besancon, France. This generates an angled beam at a frequency of 8 MHz, at an angle of 45° (in the case of the CEP18) or at an angle of 60° (in the case of the CEP21).

The transducer 34 is an angle-beam transducer which operates according to the principles disclosed at https://ndt-kits.com/what-is-angle-beam-testing/ (as published online on 2 Dec. 2024).

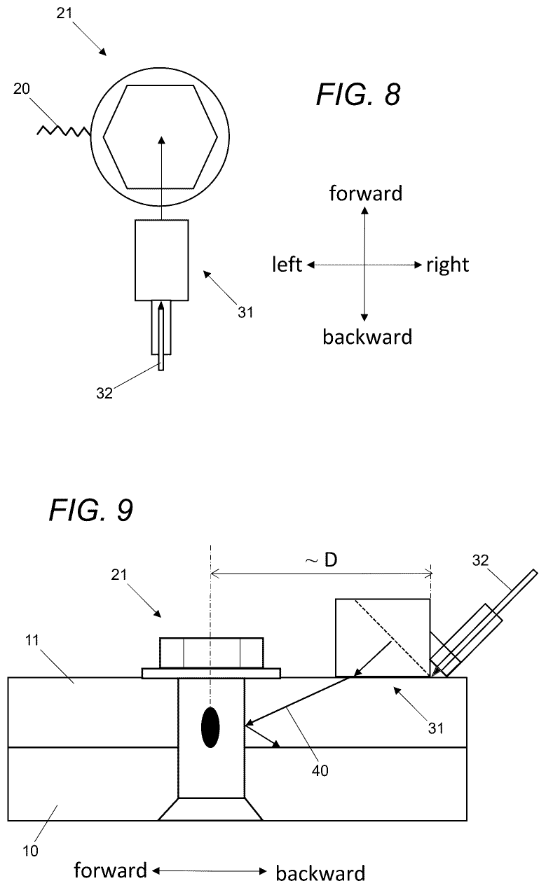

The pencil 32 is configured to provide an indicator on the surface of the spar flange 11 indicating a detection position of the probe 31, as explained below with reference to FIGS. 8 to 15.

In a first calibration stage shown in FIGS. 2 and 3, a preset distance D is measured. The transducer 34 is energised so that it emits an ultrasound beam 40 into the surface of the spar flange 11, through the wedge 33, at an oblique angle to the surface of the spar flange 11.

The probe 31 is pointed in the backward direction by the human operator, so the ultrasound beam 40 travels toward a rear edge 41 of the spar flange 11. When the probe 31 is positioned a large distance from the rear edge 41, as in FIG. 2, the ultrasound echoes do not return to the probe 31. When the probe 31 is positioned closer to the rear edge 41, as in FIG. 3, the ultrasound echoes do return to the probe 31. By moving the probe 31 in the forwards-backwards direction, the ultrasound echoes detected by the transducer 34 reach a maximum when the ultrasound 40 is reflected from the junction where the rear edge 41 of the spar flange 11 meets the cover 10 as in FIG. 3. At this position of maximum signal strength, the tip of the pencil 32 (which is at the back of the probe 31) is positioned by a preset distance D shown in FIG. 3 which depends on the angle of ultrasound beam 40 and the thickness of the spar flange 11. This distance D is measured by the operator with a ruler, and noted for use later.

The testing apparatus is then used to test for cracks around each fastener hole as shown in FIGS. 8 to 15.

The probe 31 is held by hand in contact with the surface of the spar flange 11, pointing forward as in FIG. 8. Initially the probe 31 is aligned with the fastener at a first position shown in FIG. 8 so the ultrasound 40 emitted into the surface of the spar flange 11 reflects from the fastener as shown in FIG. 9. At the first position, the tip of the pencil 32 is spaced from the centre of fastener by approximately the preset distance D, so the ultrasound reflects from the fastener 21 and the echoes do not return to the probe 31.

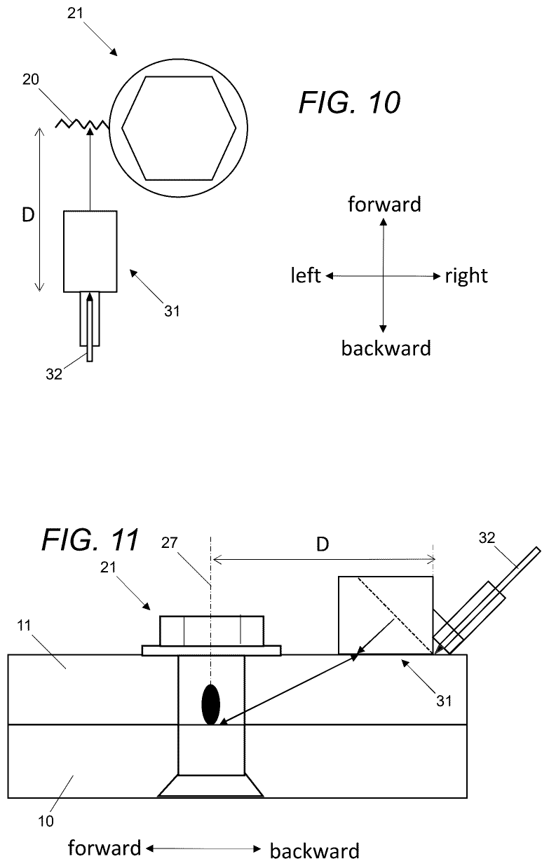

Next the probe 31 is moved across the surface of the spar flange 11 from the first position of FIG. 8, to the left. Ultrasound echoes are monitored until the probe 31 reaches a second position shown in FIGS. 10 and 11 where ultrasound echoes from the crack 20 are detected and have reached a maximum level. When the ultrasound echoes are at a maximum level, then the gain is adjusted to 80% full scale height (FSH).

In moving from the first position of FIGS. 8 and 9 to the second position of FIGS. 10 and 11, the probe 31 may be moved to-and-fro in the left-right direction, and also to-and-fro in the forward-backward direction, until the maximum level is detected. In the second position the probe is pointing directly forward, at right angles to the crack 20, and the tip of the pencil 32 is spaced by the distance D from the plane 27 of the crack 20 - the plane 27 of the crack shown in FIG. 11.

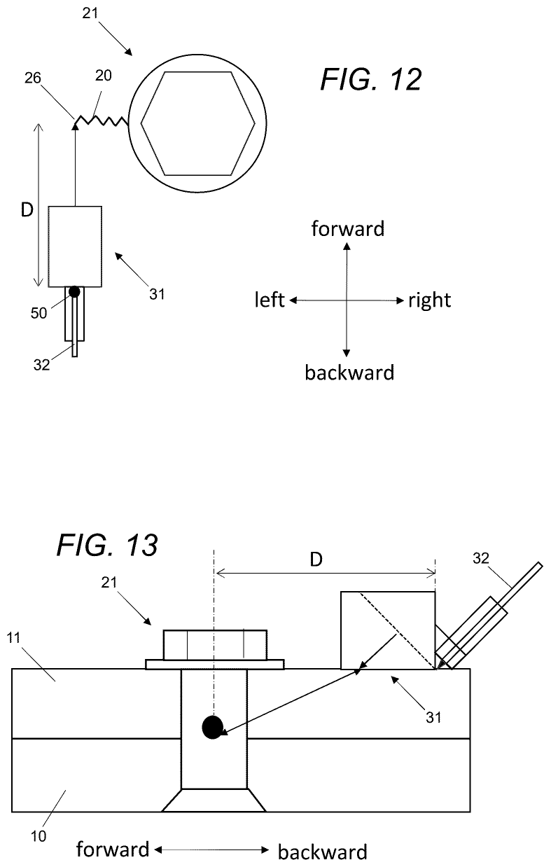

The probe 31 is then moved further to the left across the surface of the spar flange 11 from the second position. Ultrasound echoes are monitored until the probe 31 reaches a detection position shown in FIGS. 12 and 13 where ultrasound echoes from the crack 20 have reduced to a set level (for example 20% FSH) indicating the crack tip 26.

When the probe 31 has reached the detection position of FIGS. 12 and 13, the pencil 32 is used to providing an indicator 50 on the surface of the spar flange 11 indicating the detection position. The pencil 32 may have a button or other actuator (not shown) which is pressed by the operator so that the tip of the pencil 32 comes into contact with the surface of the spar flange 11, depositing an indicator 50 in the form of a graphite mark on the surface of the spar flange 11. Alternatively the pencil holder 35 may be pressed by the operator to move the pencil 32 into contact with the surface of the spar flange 11.

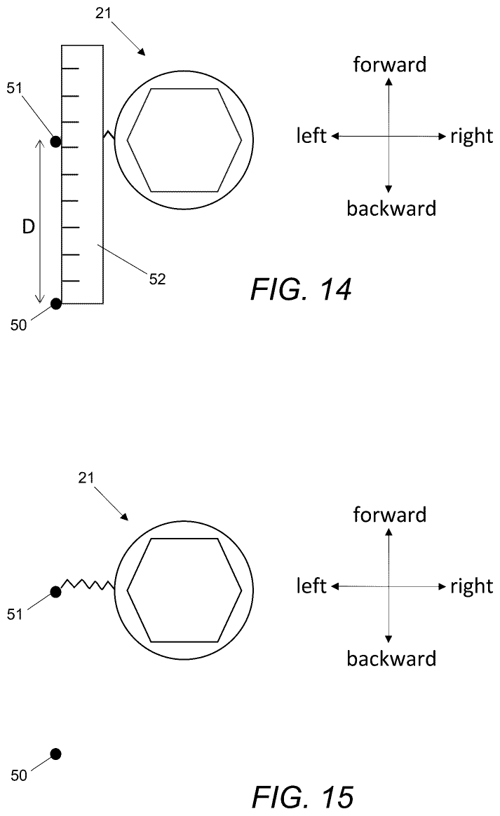

After the indicator 50 has been deposited, the probe 31 is removed by hand from the surface of the spar flange 11, leaving the indicator 50 in place as shown in FIGS. 14 and 15.

After the probe 31 has been removed from the surface of the spar flange, the operator provides a flaw marker 51 on the surface of the spar flange 11 indicating an estimated position of the crack tip 26. By way of example, the position of the flaw marker 51 may be determined by measuring the preset distance D from the indicator 50 using a ruler 52 shown in FIG. 14. The flaw marker 51 may be a graphite mark deposited by a pencil or other hand-held marking device.

As shown in FIG. 14 the flaw marker 51 is spaced from the indicator 50 by the preset distance D, and the left/right position of the flaw marker 51 is based on the left/right position of the indicator 50.

The process of detecting the crack tip 26 shown in FIGS. 8 to 13 requires the operator to perform precise movements in a confined and congested rib bay, which can lead to operator fatigue and hinder accuracy. The probe-mounted pencil 32 provides a convenient method of indicating the detection position of the probe 31 without requiring the operator to hold the pencil 32 by hand, reducing operator fatigue. The probe-mounted pencil 32 also frees up one of the operator's hands, and enables the detection position to be indicated accurately.

After all of the fasteners have been inspected, the marked locations may be reviewed for consistency and accuracy, and the ultrasonic data analysed in conjunction with the marked points. An inspection report is then generated, including the marked locations and inspection results.

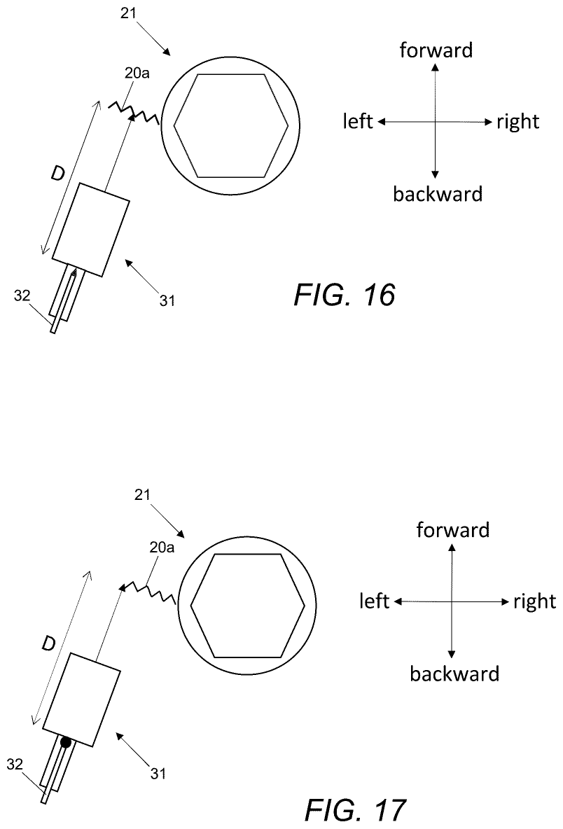

FIGS. 16 and 17 show the probe 31 detecting a crack 20a which extends at an oblique angle to the spar web 12. In moving from the first position of FIG. 8 to the second position of FIG. 16 (where the echoes are at a maximum) the probe 31 has been rotated so it points at right angles to the crack 20a, as well as being translated to the left and forward.

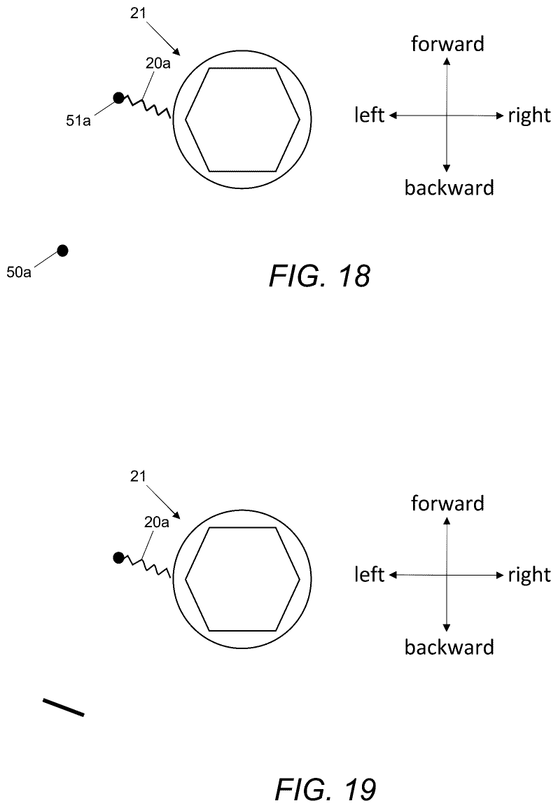

FIG. 18 shows a flaw marker 51a and indicator 50a which correspond with the detection position of FIG. 17.

FIG. 19 shows an alternative indicator 50b corresponding with the detection position of FIG. 17. The indicator 50b is a line of graphite (rather than a spot) which can be used by the operator as a visual guide to accurately align the ruler 52 at the correct angle.

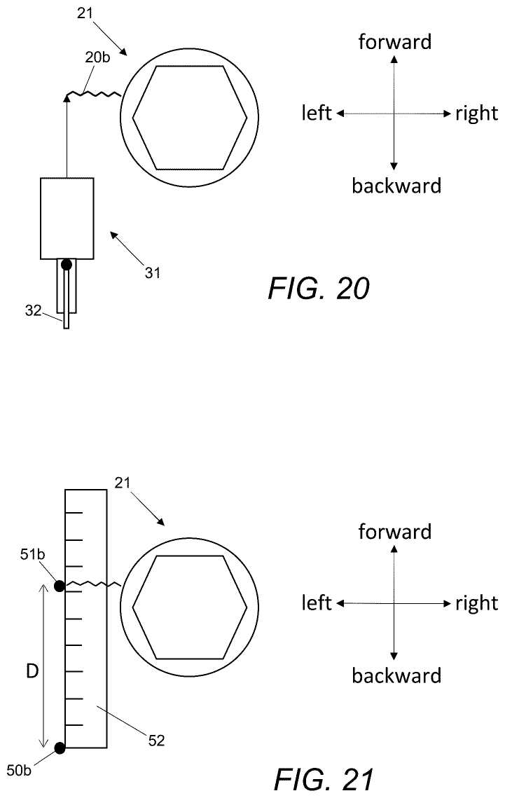

FIGS. 20 and 21 show the probe 31 detecting a crack 20b which is offset forward from the centre of the fastener. In moving from the first position of FIG. 8 to the second position of FIG. 20 (where the echoes are at a maximum) the probe 31 has been translated to the left and forward, without being rotated.

FIG. 21 shows a flaw marker 51b and indicator 50b which correspond with the detection position of FIG. 20.

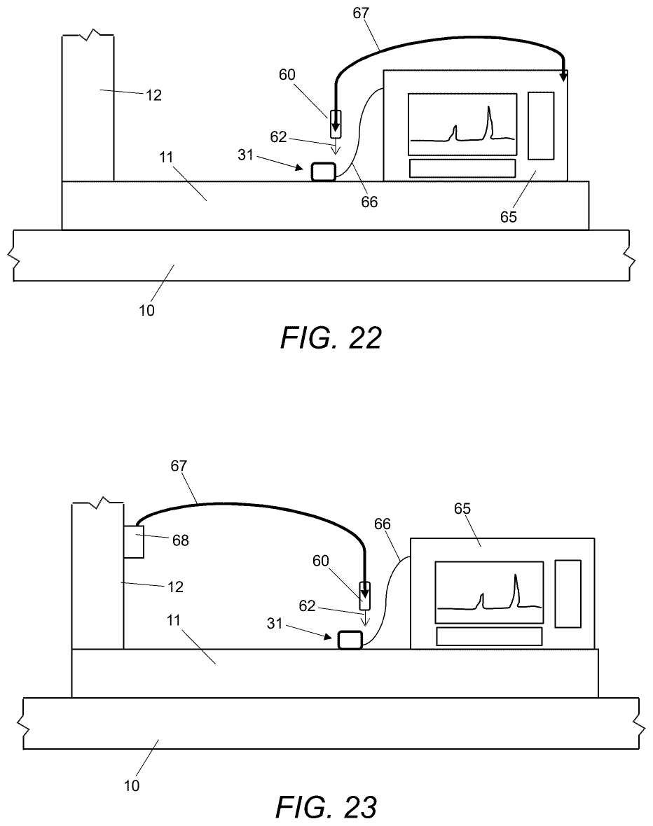

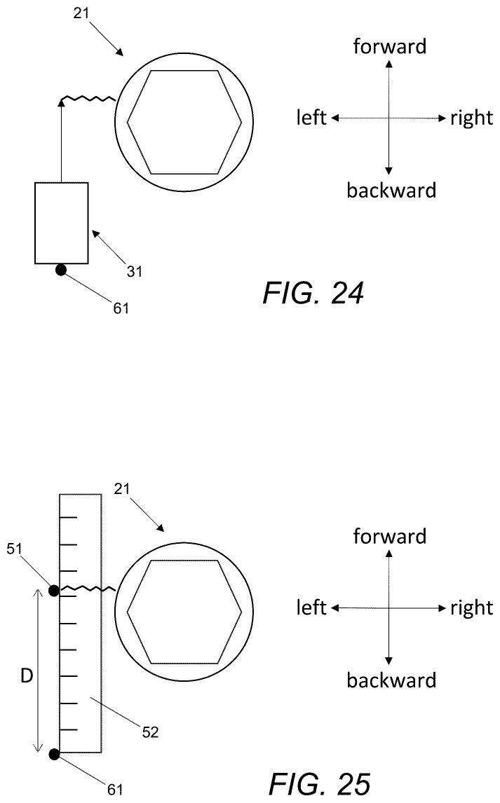

FIG. 22 shows an alternative testing apparatus. The testing apparatus comprises a probe 31 identical to the probe of FIG. 2, shown in FIG. 22 at a detection position. A light source 60, such as a laser lamp, is configured to provide a light indicator 61 (shown in FIG. 24) in the form of a light spot on the surface of the spar flange 11, indicating the detection position of the probe. In contrast to the testing apparatus of FIG. 2 (which provides a physical mark on the surface of the spar flange 11) the light source 60 illuminates the surface of the spar flange 11 at the detection position with a beam of light 62, thereby providing a light indicator 61 in the form of a light spot. In this case the light indicator 61 is a circular spot, but other shapes of light indicator (for instance a line or cross) may be projected onto the spar flange 11.

A control unit 65 is configured to operate the probe 31 by energising the ultrasonic transducer via a flexible cable 66 which connects the control unit 65 to the probe 31. A flexible light source support 67 (for instance a goose neck lamp holder) supports the light source 60 and connects the light source 60 to the control unit 65. The flexible light source support 67 is clamped or otherwise fixed to the control unit 65. The flexible light source support 67 can be adjusted to move the light source 60 relative to the control unit 65 and move a position of the light indicator 61 on the surface of the spar flange 11.

When the probe 31 has reached the detection position of FIGS. 22 and 24, the light source 60 is pointed by the operator at the back of the probe 31 to provide the light indicator 61 on the surface of the spar flange 11 indicating the detection position. The probe 31 can then be moved relative to the light source 60 so that the probe 31 can be removed from the surface of the spar flange 11, leaving the light indicator 61 in place. Thus after the light indicator 61 has been positioned correctly, the probe 31 is removed by hand from the surface of the spar flange 11, leaving the light indicator 61 in place as in FIG. 25.

After the probe 31 has been removed from the surface of the spar flange 11, the operator deposits a flaw marker 51 on the surface of the spar flange 11 indicating an estimated position of the crack tip 26, as shown in FIG. 25. As in the previous example, the position of the flaw marker 51 may be determined by measuring the preset distance D from the light indicator 61 using a ruler 52. Alternatively the operator may mark the position of the light indicator 61 with a pencil, move the light source 60 away, and then use the pencil mark as the datum point for determining the position of the crack tip 26.

FIG. 23 shows a further alternative testing apparatus. The testing apparatus of FIG. 23 is similar to the testing apparatus of FIG. 22 (and is used in a similar way) except the flexible light source support 67 is configured to connect the light source 60 to a support structure (in this case the spar web 12) rather than to the control unit 65. The flexible light source support 67 can be adjusted to move the light source 60 relative to the support structure and move a position of the light indicator on the surface of the spar flange 11. The flexible light source support 67 may be temporarily attached to the support structure by a vacuum cup 68 or other attachment device.

In this example the support structure is the spar web 12, but in other cases the vacuum cup 68 may be attached to the rib 14 or any other support structure inside the rib bay.

In the embodiments above, the method is used to detect a crack, but in other embodiments the method may be used to detect other types of flaw

In the embodiments above, the method is used to detect a periphery of a flaw, but in other embodiments the method may be used to detect another part of a flaw, such as a centre of a flaw.

In the embodiments above, the method is used to detect a flaw in an aircraft part, but in other embodiments method may be used to detect a flaw in another type of part.

Where the word ‘or’ appears this is to be construed to mean ‘and/or’ such that items referred to are not necessarily mutually exclusive and may be used in any appropriate combination.

Although the invention has been described above with reference to one or more preferred embodiments, it will be appreciated that various changes or modifications may be made without departing from the scope of the invention as defined in the appended claims.

1. A method of indicating a position of a flaw in a part, comprising:
holding a probe by hand in contact with a surface of the part with a probe;
detecting a flaw in the part by emitting ultrasound from the probe into the surface of the part and detecting echoes of the ultrasound from the flaw;
providing an indicator on the surface of the part indicating a detection position of the probe;
after the indicator has been provided, removing the probe by hand from the surface of the part, leaving the indicator in place; and
after the probe has been removed from the surface of the part, providing a flaw marker on the surface of the part indicating an estimated position of the flaw, wherein the flaw marker is spaced from the indicator and a position of the flaw marker is based on a position of the indicator; wherein the indicator comprises material deposited on the surface of the part at the detection position by a probe-mounted marking device which is mounted to the probe, or the indicator is a light indicator provided by a beam of light which illuminates the surface of the part at the detection position.

2. The method according to claim 1, wherein the position of the flaw marker is determined by measuring a preset distance from the position of the indicator.

3. The method according to claim 2, wherein the preset distance is measured by a ruler.

4. The method according to claim 1, wherein the flaw marker comprises material deposited by a hand-held device.

5. The method according to claim 1, further comprising moving the probe across the surface of the part from a first position; monitoring ultrasound echoes until the probe reaches a second position where ultrasound echoes from the flaw are detected; then further moving the probe across the surface of the part from the second position and monitoring ultrasound echoes until the probe reaches the detection position where ultrasound echoes from the flaw have reduced to a level indicating a periphery of the flaw.

6. The method according to claim 5, wherein the flaw is a crack, and the periphery of the flaw is a tip of the crack.

7. The method according to claim 1, wherein the indicator comprises material deposited on the surface of the part at the detection position by a probe-mounted marking device which is mounted to the probe.

8. The method according to claim 7, wherein the indicator comprises graphite deposited on the surface of the part at the detection position by the probe-mounted marking device.

9. The method according to claim 1, wherein the indicator is a light indicator, such as a light spot, provided by a beam of light which illuminates the surface of the part at the detection position.

10. The method according to claim 1, wherein the ultrasound is emitted into the surface of the part by an ultrasound beam which is at an oblique angle to the surface of the part.

11. The method according to claim 1, wherein the probe comprises a wedge and an ultrasonic transducer mounted to the wedge.

12. A testing apparatus, comprising:
a probe configured to contact a surface of a part, the probe comprising a wedge and an ultrasonic transducer mounted to the wedge; and a probe-mounted marking device mounted to the probe, wherein the probe-mounted marking device is configured to provide an indicator on the surface of the part indicating a detection position of the probe by depositing material on the surface of a part.

13. The testing apparatus according to claim 12, wherein the probe-mounted marking device comprises a pencil.

14. A testing apparatus, comprising:
a probe configured to contact a surface of a part, the probe comprising a wedge and an ultrasonic transducer mounted to the wedge; and a light source configured to provide a light indicator on the surface of the part indicating a detection position of the probe by illuminating the surface of the part at the detection position with a beam of light, wherein the probe can be moved relative to the light source so that the probe can be removed from the surface of the part, leaving the light indicator in place.

15. The testing apparatus according to claim 14, further comprising a flexible light source support configured to support the light source and connect the flexible light source to a support structure, wherein the flexible light source support can be adjusted to move the light source relative to the support structure and move a position of the light indicator on the surface of the part.

16. The testing apparatus according to claim 14, further comprising a control unit configured to operate the probe by energising the ultrasonic transducer; a flexible cable connecting the control unit to the probe; and a flexible light source support which supports the light source and connects the light source to the control unit, wherein the flexible light source support can be adjusted to move the light source relative to the control unit and move a position of the light indicator on the surface of the part.
